(19) United States
(12) Patent Application Publication
(10) Pub. No.: US 2017/0244908 A1
(43) Pub. Date: Aug. 24, 2017

(54) VIDEO BACKGROUND REPLACEMENT SYSTEM

(71) Applicant: GenMe Inc., Marina Del Rey, CA (US)

(72) Inventors: Julien Charles Flack, Swanbourne (AU); Steven Pegg, Perth (AU); Hugh Sanderson, Shenton Park (AU)

(21) Appl. No.: 15/439,836

(22) Filed: Feb. 22, 2017

Related U.S. Application Data
(60) Provisional application No. 62/298,293, filed on Feb. 22, 2016.

(51) Int. Cl. H04N 5/272; H04N 7/01; G11B 27/036; G06K 9/00; G06K 9/46

(52) U.S. Cl. CPC H04N 5/272; G06K 9/00234; G06K 9/4652; G06K 9/4628; G11B 27/036; H04N 7/0117

(57) ABSTRACT

A video background processing system is disclosed that is configured to receive a video stream including a plurality of successive first video frames at a first resolution. The system comprises a video resolution modifier configured to reduce the resolution of the first video frames from the first resolution to a second resolution lower than the first resolution and thereby generate second video frames. The system also comprises a foreground determiner configured to determine a foreground portion and a background portion in the second video frames and to produce first foreground data indicative of locations of the foreground and background portions in the second video frames at the second resolution, wherein the foreground determiner is configured to use the first foreground data to generate second foreground data indicative of locations of the foreground and background portions in the first video frames. The system also comprises a compositor circuit configured to use replacement background content and the second foreground data to generate combined video frames at the first resolution, each combined video frame including the foreground portion from a first video frame and the replacement background content. A corresponding method is also disclosed.

### FIELD OF THE INVENTION

The described technology generally relates to a video background replacement system.

### BACKGROUND OF THE INVENTION

Techniques for identifying target foreground portions in a video stream and removing background video information from the video stream typically require significant processing power to create and update background pixel models. In an existing technique wherein the object desired to be identified as foreground is a person, face detection and tracking are required to be performed in order to identify the location of the person, and this requires further computational power. Additional computational power is also required as the resolution of the video stream increases.

Accordingly, as the resolution of cameras on computing devices, including personal computers, tablet computers and smart phones, increases it becomes impractical to use existing video background replacement techniques in real-time without significant degradation in quality.

In this specification, an image in a video frame comprises a ‘foreground portion’ that represents a part of the image considered to be in the foreground of the image, and a ‘background portion’ that represents a part of the image considered to be in the background of the image. Typically, the foreground portion is a part of the image that corresponds to at least part of a person, and the background portion corresponds to the remainder of the image.

### SUMMARY OF THE INVENTION

In accordance with a first aspect of the present invention, there is provided a video background processing system, the system arranged to receive a video stream including a plurality of successive first video frames at a first resolution, the system comprising:
a video resolution modifier circuit arranged to reduce the resolution of the first video frames from the first resolution to a second resolution lower than the first resolution and thereby generate second video frames;
a foreground determiner circuit arranged to determine a foreground portion and a background portion in the second video frames and to produce first data indicative of locations of the foreground and background portions in the second video frames at the second resolution, wherein the system is arranged to use the first data to generate second data indicative of locations of the foreground and background portions in the first video frames; and
a compositor circuit arranged to use replacement background content and the second data to generate combined video frames at the first resolution, each combined video frame including the foreground portion from a first video frame and the replacement background content.

In an embodiment, the first data is a first alpha matte wherein each pixel of the first alpha matte is indicative of whether an associated pixel in the second video frame is part of the foreground portion or part of the background portion, the first alpha matte having a first alpha matte resolution.

In an embodiment, each pixel of the first alpha matte has an associated first alpha value representing a transparency of the pixel. The first alpha value may vary between a defined minimum first alpha value and a defined maximum first alpha value, the defined minimum first alpha value indicating that a first alpha matte pixel is fully transparent and the associated video frame pixel is definitely part of the background portion, and the defined maximum first alpha value indicating that the first alpha matte pixel is fully opaque and the associated video frame pixel is definitely part of the foreground portion.

In an embodiment, the foreground portion is an image of a person.

In an embodiment, the foreground determiner circuit includes a face detector arranged to detect a face in a second video frame.

In an embodiment, the face detector generates a bounding box that identifies the size and position of the detected face relative to the second video frame.

The face detector may include a Haar like face detector, for example arranged to identify a face with a strongest response from the Haar detector.

In an embodiment, the face detector includes a facial landmark detector arranged to identify pixels in a video frame representing points of interest on a face of a person. The points of interest may include a mouth, nose, eyes and/or chin of a person.

In an embodiment, the foreground determiner circuit includes a torso modeller arranged to use the bounding box to generate a torso model of a head and upper body of the user associated with the detected face. The torso modeller may use a parameterised model of the head and upper body, the parameters including a position and radius of a skull, a width of the neck, and/or a height of left and right shoulders of the user measured relative to a position of the detected face.

In an embodiment, the foreground determiner circuit includes a background handler arranged to identify pixels in a second video frame that fall outside the torso model, but that properly form part of the foreground portion. The background handler may store average RGB values for each pixel identified by the torso modeller as background portion.

In an alternative embodiment, the foreground determiner circuit includes a classifier arranged to detect pixels of the foreground portion. The classifier may be configured to classify all pixels in a second video frame as foreground or background depending on the pixel colour (RGB) and position (x,y) relative to other pixels in the second video frame.

In an embodiment, the classifier may comprise a Convolutional Neural Network (CNN), which may be trained to classify pixels as foreground or background with an associated probability.

In an embodiment, the foreground determiner circuit includes a colour cube arranged to store associations between pixel RGB colour, pixel XY position and the first alpha matte value associated with the pixel.

In an embodiment, the colour cube quantizes the RGB XY space into a smaller set of samples or bins. 32 bins may be used for the RGB colour space, with each colour bin covering a range of colours, and 20 bins may be used for the XY positions, with each XY bin covering a range of positions. The first alpha matte values of pixels in the RGB bins and XY bins may be averaged.

In an embodiment, the foreground determiner circuit includes a colour cube updater arranged to manage creation and updating of the colour cube.

In an embodiment, the foreground determiner circuit includes a colour cube applier arranged to apply the colour cube to the second video frames in order to generate the first alpha matte. The colour cube may be applied by matching the RGB and XY information associated with each pixel to the closest bin in the colour cube and assigning the first alpha matte value stored in the colour cube as the first alpha matte value for the pixel.

In an embodiment, the foreground determiner circuit includes a change detector arranged to determine whether significant changes exist between a second video frame and a previous second video frame, wherein if significant changes are determined to exist, a new first alpha matte is generated, and if significant changes are not determined to exist, an existing colour cube is used.

In an embodiment, the video resolution modifier circuit comprises a spatial sub sampler. The spatial sub-sampler may use a bilinear down sampling technique to reduce the number of pixels in the first video frames. Alternatively, the spatial sub-sampler may reduce the number of pixels in the first video frames by selecting the median RGB or median luminance value of a group of pixels in the first video frames to represent the RGB value at the sub sampled resolution.

In an embodiment, the second data is a second alpha matte, and the system comprises an alpha matte generator arranged to use the first alpha matte and the first video frames to generate the second alpha matte, each pixel of the second alpha matte being indicative of whether an associated pixel in a first video frame is part of the foreground portion or part of the background portion, and the second alpha matte having a second alpha matte resolution higher than the first alpha matte resolution.

In an embodiment, the system also comprises at least one filter for application to the foreground portion and/or the replacement background content.

In an embodiment, the system comprises a boundary filter arranged to adjust the first video frames by modifying colours in the first video frames at a boundary between the foreground portion and the background portion using the second alpha matte.

In an embodiment, the system comprises a user editor arranged to enable the user to indicate a portion of a video frame that has been incorrectly assigned to a foreground portion or a background portion, and in response the system reassigns the indicated incorrectly assigned portion to the relevant correct foreground or background portion.

The at least one filter may include a colour rebalancer arranged to modify the relative colour tone and/or brightness of the foreground portion and the replacement background content. The colour rebalancer may be arranged to analyse a RGB histogram of the foreground portion or the replacement background content, and the colour rebalancer may be arranged to calculate an average of the RGB histogram of the foreground portion or the replacement background content over a defined time period.

In an embodiment, the colours of the RGB histogram of the background are weighted based on their spatial position. The colours of the RGB histogram may be weighted so that colours in lower and central parts of the image have a greater effect on an overall colour average.

In an embodiment, the weighted colours of the background are used by the colour rebalancer to generate a gamma value for each RGB colour channel of the foreground image, the gamma value being used to adjust the average of each colour channel of the foreground portion or replacement background content to be in accordance with the respective colour averages of the replacement background content or foreground portion.

In an alternative embodiment, the background colour average is weighted based on the location of the foreground portion relative to the replacement background content in the combined video frame. In an embodiment, if the foreground portion is positioned on a first side of the replacement background content, the background content average is more heavily weighted towards a second opposite side of the combined video frame.

The system may comprise a colour filter arranged to apply a sepia tone, for example to both the foreground and the replacement background content; a filter arranged to apply increased brightness to a foreground portion and/or to apply decreased brightness to the replacement background content; an image sharpening filter; and/or an image blurring filter.

In an embodiment, the system comprises at least one camera arranged to produce the video stream.

In an embodiment, the system is arranged to receive the video stream from a video stream source, from example from a video storage device or a video stream source connected to the system through a network such as the Internet.

In an embodiment, the system includes user settings indicative of user configurable settings usable by components of the system. In an embodiment, the user settings include video capture settings indicative of which camera to use to generate the video stream and the resolution and frame rate that the camera should use; information indicative of a replacement background image or video to use; information that identifies whether to apply one or more filters to the replacement background image/video or the identified foreground portion of the video stream, such as whether to perform colour rebalancing of the replacement background image/video or the identified foreground portion of the video stream so as to improve the colour levels of the foreground relative to the replacement background image/video; information indicative of the user's physical appearance for use by the system in more easily identifying the user; information indicative of the sub-sampling factor to apply to the video stream received from the camera; and/or a video resolution reduction factor indicative of the amount of resolution reduction that is to be applied to the video stream from the video camera.

In an embodiment, the user settings enable a user to control a trade-off between performance and quality.

In an embodiment, the video resolution modifier circuit is arranged to reduce the resolution of the first video frames from the first resolution to a second resolution using a video down sampling factor, and the user settings include a setting that enables a user to select the video down sampling factor.

In an embodiment, the replacement background content is derived from existing background content in the video stream by modifying the existing background content. In an embodiment, the replacement background content is produced by applying an image modifier circuit arranged to blur the existing background portion.

In an embodiment, the system comprises a background content storage device arranged to store replacement background content.

In an embodiment, the system comprises a selector arranged to facilitate selection of replacement background content. The selector may be arranged to facilitate selection of replacement background content automatically or by a user.

In accordance with a second aspect of the present invention, there is provided a method of replacing a background portion in a video stream having a foreground portion and a background portion, the method comprising:
receiving a video stream including a plurality of successive first video frames at a first resolution;
reducing the resolution of the first video frames from the first resolution to a second resolution lower than the first resolution using a video resolution modifier circuit to thereby generate second video frames;
determining a foreground portion and a background portion in the second video frames and producing first data indicative of locations of the foreground and background portions in the second video frames at the second resolution using a foreground determiner circuit;
using the first data to generate second data indicative of locations of the foreground and background portions in the second video frames; and
using replacement background content and the second data to generate combined video frames at the first resolution, each combined video frame including the foreground portion in a first video frame and the replacement background content.

In accordance with a third aspect of the present invention, there is provided a video background processing system, the system arranged to receive a video stream including a plurality of successive first video frames at a first resolution, the system comprising:
a video resolution modifier circuit circuit arranged to reduce the resolution of the first video frames from the first resolution to a second resolution lower than the first resolution and thereby generate second video frames;
a foreground determiner circuit circuit arranged to determine a foreground portion and a background portion in the second video frames and to produce first data indicative of locations of the foreground and background portions in the second video frames at the second resolution, wherein the system is arranged to use the first data to generate second data indicative of locations of the foreground and background portions in the first video frames; and
a compositor circuit arranged to use replacement background content and the second data to generate combined video frames at the first resolution, each combined video frame including the foreground portion from a first video frame and the replacement background content.

### BRIEF DESCRIPTION OF THE DRAWINGS

The present invention will now be described, by way of example only, with reference to the accompanying drawings, in which:

FIG. 1 is a diagrammatic representation of a video background processing system in accordance with an embodiment of the present invention;

FIG. 2 is a diagrammatic representation of a smart phone on which the system of FIG. 1 is implemented;

FIGS. 3 and 4 show how a high resolution alpha matte is calculated from a low resolution alpha matte and an associated high resolution video frame;

FIG. 5a is diagrammatic representation of a foreground determiner circuit of the video background processing system shown in FIG. 1;

FIG. 5b is diagrammatic representation of an alternative foreground determiner circuit of the video background processing system shown in FIG. 1;

FIG. 6 is a diagrammatic representation of a frame of a video stream including a person that constitutes a foreground portion in a scene;

FIG. 7 is a diagrammatic representation of alternative background content that is desired to replace a background portion in the video stream shown in FIG. 6;

FIG. 8 is a diagrammatic representation of a frame of a composite video stream including the person shown in FIG. 6 superimposed on the alternative background content shown in FIG. 7;

FIG. 9 is a flow diagram showing steps of a method of replacing a background portion in a video stream with replacement background content; and

FIG. 10 is a flow diagram showing steps of a method of determining foreground and background portions of frames in a video stream.

### DESCRIPTION OF AN EMBODIMENT OF THE INVENTION

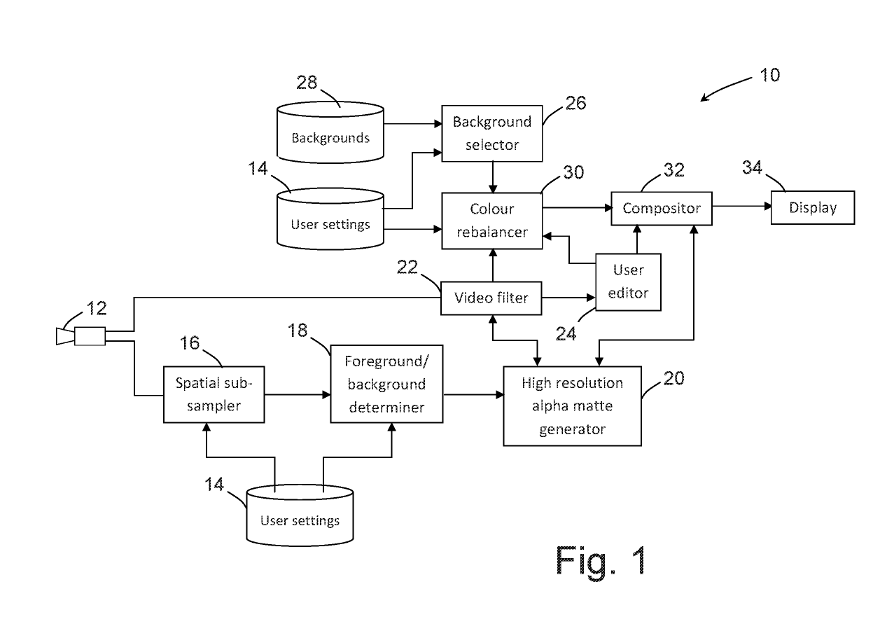

Referring to the drawings, FIG. 1 shows a video background processing system 10 in accordance with an embodiment.

The system 10 implements an efficient, automated background substitution arrangement which may be implemented using consumer devices, including personal computers, tablet computers and smart phones, in real-time without problematic degradation in video or image quality. This is achieved by performing computationally expensive processing operations on a sub-sampled video stream and therefore reduced resolution set of video frames, then using intelligent image adaptive up scaling techniques to produce high resolution, real-time composite image frames at the original video resolution.

In the present embodiment, the computing device on which the system is implemented is a smart phone device having a video capture device in the form of a video camera directed or directable towards a user of the device, although it will be understood that other computing devices are envisaged, such as personal computers and tablet computers.

In this embodiment, the system 10 is implemented using hardware circuitry, memory circuitry (e.g., a storage device) of the computing device and software configured to implement components of the system, although it will be understood that any hardware/software combination is envisaged.

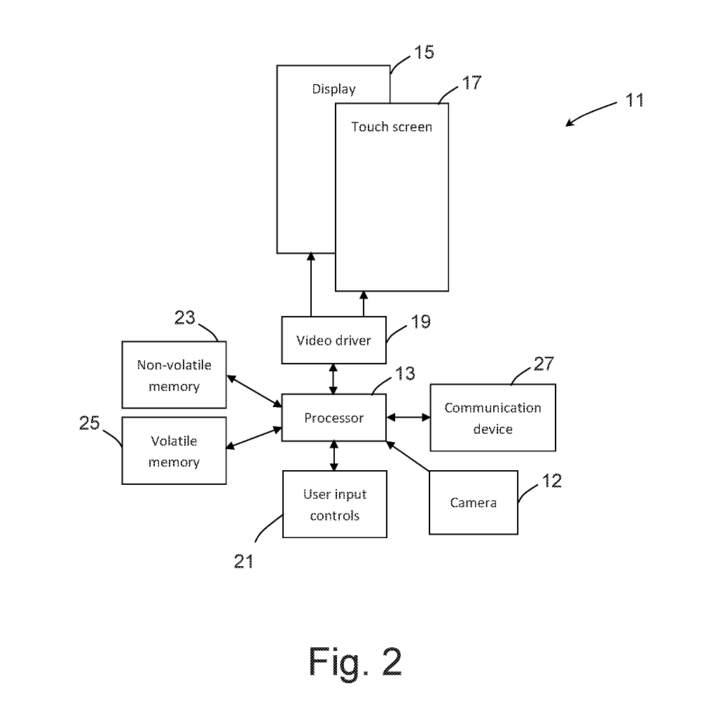

An exemplary smart phone 11 on which the system 10 is implemented is shown in FIG. 2. The smart phone 11 includes a hardware processor 13 (e.g., a hardware processor circuit) arranged to control and coordinate operations in the smart phone 11, a display 15, a touch screen 17 that overlies the display 15 and that is arranged to enable a user to interact with the smart phone 11 through touch, and a video driver 19 arranged to control the display 15 and touch screen 17 and provide an interface between the processor 13 and the display and touch screen 17.

The smart phone 11 also includes user input controls (e.g., graphical or other user interface, button or input) 21 that in this example take the form of dedicated buttons and/or switches that for example control volume, provide on/off control and provide a ‘home’ button usable with one or more applications implemented by the smart phone 11.

The smart phone 11 also includes non-volatile memory 23 arranged to store software usable by the smart phone, such as an operating system implemented by the smart phone 11 and application programs and associated data implementable by the smart phone 11, and volatile memory 25 required for implementation of the operating system and applications.

The smart phone 11 also includes a communication device 27 arranged to facilitate wireless communications, for example through a W-Fi network or a telephone network. The smart phone 11 also includes the camera 12.

Video stream data from the video camera 12 is captured and processed by the system in real time in order to identify a foreground portion in frames of the video stream, in this example the foreground portion of interest being an image of a person, which may be a user of the smart phone 11, for example a head and torso of the person, and the identified image of the person is superimposed by the system 10 on selected alternate background content, which may be a still image or video. In this way, the user is provided with a displayed video stream that shows a video image of the person together with the selected alternate background image or video.

However, while the present example uses a video camera 12 to produce a video stream, it will be understood that other variations are possible. For example, the video stream may be obtained from other sources, such as from a storage device, or from a remote location through a network such as the Internet.

The system 10 reduces the resolution of the video frames of the camera video stream and processes the reduced resolution video frames so as to separate image pixels which represent the user's head, hair and body (and are identified as a foreground portion) from pixels that represent a background portion. Background pixels are defined as any pixels in the image which are not part of the foreground portion. Since it is common for image pixels at a boundary between the foreground and background portions to contain a mixture of colour information, the system 10 is arranged such that pixels at or near the boundary between the foreground and background portions are identified and assigned a semi-transparent alpha value.

After the foreground portion, along with semi-transparent border pixels, has been identified it is possible to create a composite video frame by replacing the background pixels in the high resolution video frames from the camera 12 with an alternative selected image or video. This involves alpha blending the identified foreground portion onto the pixels of the alternate background image or video using standard image compositing techniques. Foreground pixels that are not part of the semi-transparent alpha edge area obscure any background pixels. The semi-transparent border regions are blended with the background according to the alpha value of the foreground.

The system 10 shown in FIG. 1 includes user settings 14 stored in permanent memory of the device, the user settings 14 indicative of user configurable settings usable by components of the system. In this example, the user settings 14 include video capture settings indicative of which camera 12 of the device to use to capture the video stream and the resolution and frame rate that the camera should use. The user settings 14 also include information indicative of a selected replacement background image or video to use, information that identifies whether to apply a filter, such as a filter arranged to perform colour rebalancing of the selected replacement background image/video or the identified foreground portion of the video stream so as to improve the colour levels of the foreground relative to the selected background image/video. The user settings 14 may also include information indicative of a person's physical appearance for use by the system 10 in more easily identifying the person as part of the foreground portion, and information indicative of the sub-sampling factor to apply to the video stream received from the camera 12. The user settings may also include a video resolution reduction factor indicative of the amount of resolution reduction that is to be applied to the video stream.

The user settings 14 may be modifiable by a user, for example using the touch screen 17 and/or the user controls 21 of the device 11.

The system includes a video resolution modifier (e.g., circuit), in this example a spatial sub sampler 16 arranged to reduce the number of image pixels that need to be processed for each video frame of the video stream. For example, the resolution of the video stream may be 720p with 1024×720 pixels per frame at 30 frames per second. By reducing the number of pixels to be processed, the complexity of foreground analysis is significantly reduced and the computational power required is therefore also reduced. This ensures that the foreground analysis process can complete without unduly affecting device performance.

In the present embodiment, the spatial sub-sampler 16 uses a bilinear down sampling technique to reduce the number of pixels that need to be processed by a foreground determiner circuit (e.g., foreground and/or background determiner circuit) 18.

However, it will be understood that other sub-sampling techniques may be used. For example in an alternative embodiment, the median RGB or median luminance value of a group of pixels is selected in the original image to represent the RGB value at the sub sampled resolution.

The stored user settings 14 determine the video down sampling factor implemented by the spatial sub-sampler 16. For example, if the sub sampling factor is set to 50% of the original resolution of the video stream received from the camera 12, a high quality composite image is ultimately achieved that includes a well-defined foreground portion. Therefore, in this example wherein the video stream is in 720p format, a 1024×720 video frame would be sub sampled to 512×360. Alternatively, if a user wishes to ensure that the processing load of the foreground determiner circuit 18 is lower still, for example in order to ensure that other processing subsystems can still operate at a high frame rate without introducing lag or latency into the video processing pipeline, the sub sampling may be set lower, for example to 10% of the original resolution. In this example, a 1024×720 video frame would be sub sampled to 102×72.

It will be understood that by facilitating selection of the video down sampling factor, a user is able to control the trade-off between performance and quality. The video down sampling factor may be selected using a suitable graphical interface, such as a touch screen interface, that facilitates selection by a user of a “quality” setting between 100% and 0%.

The system 10 also includes a foreground determiner circuit 18 arranged to process the sub sampled video to generate first data, in this example a low resolution alpha matte, that includes information indicative of a foreground portion and a background portion of a frame of the sub sampled video. The alpha matte is an image of the same size as a video frame of the sub sampled video stream in which the alpha value of each pixel of the alpha matte image represents the transparency of the pixel.

It will be understood that in this example the alpha value associated with a pixel in the alpha matte image is indicative of whether the associated pixel in the video frame of the sub sampled video is part of the foreground portion (and therefore part of the image of the user) or part of the background portion. The alpha value in this example is stored as an 8 bit number with range from 0 to 255. A value of 0 indicates that the alpha matte pixel is fully transparent and the associated video frame pixel is definitely part of the background. A value of 255 indicates that the alpha matte pixel is fully opaque and the associated video frame pixel is definitely part of the foreground. Values between 0 and 255 indicate a degree of certainty that the associated video frame pixel belongs to the foreground or the background portions. For example, an alpha matte pixel value of 128 indicates that the pixel is semi-transparent and therefore the associated video frame pixel is equally likely to be either a foreground or a background pixel. However, while in the present example the alpha value is an 8 bit number, it will be understood that other variations are possible, for example a 10 bit or 16 bit number.

The system 10 also includes a high resolution alpha matte generator 20 arranged to generate second data, in this example a high resolution alpha matte, using the low resolution alpha matte generated by the foreground determiner circuit and the full resolution video stream.

Each pixel of the high resolution alpha matte is influenced by a rectangular patch of input pixels of the low resolution alpha matte and the sub-sampled video stream, which may be a 3×3 or 5×5 patch of pixels. Each patch is centered upon the output pixel of the high resolution alpha matte and the high resolution video stream. The influence of each input pixel is based on its distance to the output pixel but also its colour difference; the closer the match the more influence it has. The distance between the output and input pixel is the maximum of the difference in X or Y coordinates. If the distance (in input pixels) is less than the patch radius then the input pixel has maximum influence. This fades off linearly to zero influence over the distance of half an input pixel.

The first step in deciding how much variation in colour affects the influence of an input pixel is to determine a threshold value. The threshold is based on the average of the colour differences between the output and input pixels plus a constant. During this step the effect of each input pixel's colour difference is modified by its distance weighting; the less the pixel weighting the less effect its colour difference will have on the threshold calculation. The effect of each input pixel on the output pixel is the sum of the colour difference multiplied by the pixel weight for each input pixel. This total is divided by the total summed pixel weight. A constant value is added to ensure that all input pixels contribute to the results. The output alpha value can now be calculated as the weighted sum of the input pixel alphas divided by the total summed weight. The weight of each input pixel is the threshold value minus the colour difference, multiplied by the distance weight. This value is clipped to never be less than one so all input pixels contribute a little to the output alpha.

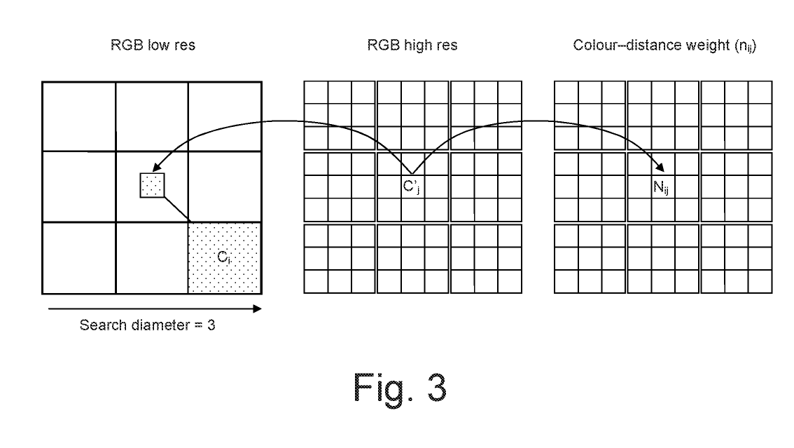

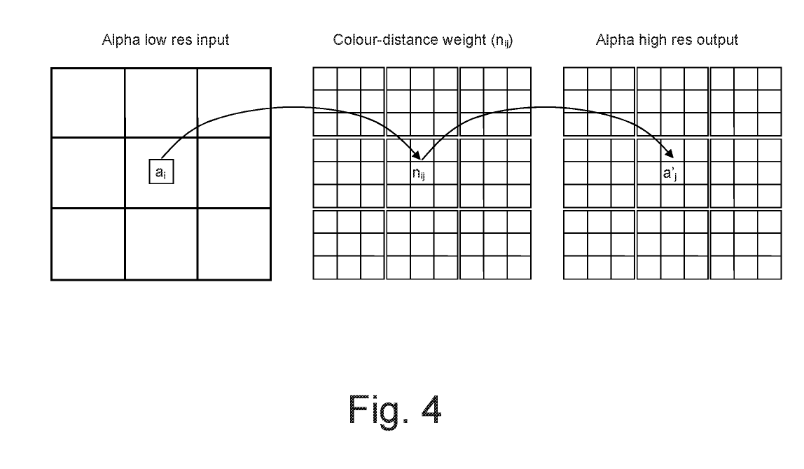

FIGS. 3 and 4 show how a high resolution alpha matte is calculated from a low resolution alpha matte and an associated high resolution video frame. The following variables are defined:

cᵢ=RGB input at position i
aᵢ=alpha input at position i
c′ⱼ=RGB output at position j
a′ⱼ=alpha output at position j
s=the search diameter of the patch in input coordinates, eg 3 for a 3×3 group of pixels.

FIG. 3 shows how spatial and colour differences are combined into a weight factor, which is used to weight the contribution of the pixels in the lower resolution alpha matte. The colour difference |cᵢ−c′ⱼ| is measured by summing the absolute colour differences between the red, green and blue colour components. The spatial difference is the maximum of the x and y coordinate differences between the high resolution RGB position c′ⱼ and the low resolution RGB position ci within the search diameter s (which is set to 3 in this example).

The search radius r is calculated from the search diameter, as follows:

r=s/2.0−0.5

The distance weight dᵢⱼ is calculated from the distance between the relative x,y position of the low resolution RGB pixel from the location of the high resolution RGB pixel, as follows:

dᵢⱼ=max(|i.x−j.x|,|i.y−j.y|)

The distance weight for each pixel in the output array is defined as:

wᵢⱼ=max(1−2*(dᵢⱼ−r),1)

A threshold value T is calculated to account for colour variances within the image, as follows:

T=SUM(wᵢⱼ*∥cᵢ−c′ⱼ∥)/SUM(wᵢⱼ)+k

As shown in FIG. 3. The following is used to calculate the weighting of input i towards output j based on distance and colour:

nᵢⱼ=max((T−∥cᵢ−c′ⱼ∥)*wᵢⱼ,I)

FIG. 4 shows the final step of combining the colour distance weighting generated by FIG. 3 into a final output alpha value for a′, at high resolutions by multiplying the low resolution alpha input aᵢ with the colour distance weight nᵢⱼ, as follows:

a′ⱼ=SUM(nᵢⱼ*a)/SUM(nᵢⱼ)

The system also comprises a video filter 22 arranged to adjust the video frames of the high resolution video stream by modifying the colours in the video frames at the boundary between the foreground portion and the background portion identified by the high resolution alpha matte. At the boundary between the foreground portion and the background portion, the image pixels may contain a mix of colour information from both the foreground portion and the background portion, and the video filter 22 modifies the pixels of the image frame of the high resolution video stream around the edges of the foreground portion so as to avoid noticeable bleeding from the background portion.

In some situations, such as in environments with poor lighting or wherein the colours in the foreground and background portions are similar, the foreground determiner circuit 18 is not able to identify the foreground portion with sufficient accuracy. For this purpose, in this example, the system 10 includes a user editor 24 arranged to enable the user to manually correct the results of the background removal process. In an embodiment, the user is able to indicate a portion of the image that has been incorrectly assigned, for example using a mouse or by interacting with the touch screen 17 of the device.

For example, if the area indicated by the user is shown as part of the foreground portion, the user editor 24 changes the area to foreground. Similarly, if the area indicated by the user is shown as part of the background portion, the user editor 24 changes the area to background.

In a particular implementation, a SLIC superpixel segmentation process is used wherein pixels in a video frame are grouped and segments re-assigned to or from the foreground portion in the area indicated by the user. In an alternative embodiment, selection by the user of an incorrect area is used to modify a torso modeller (described in more detail below) so that the areas indicated by the user are used in the evaluation of the torso models and the functionality of the torso modeller is thereby improved.

In this example, the system also includes a background selector 26 arranged to facilitate selection, in this example, by a user of a replacement background that is to form a composite video with the identified foreground portion. The background selector 26 in this example includes a user interface component that allows the user to select an image, video or other graphic element from a background content storage device 28. In this example, the background content storage device 28 includes alternate background images and videos.

Alternatively, the background selector 26 may be arranged to select a replacement background automatically.

As an alternative to new background content, the replacement background content may be a modified version of the existing background portion. For example, the replacement background may be produced by applying a suitable image modifier circuit to the existing background portion that is arranged to blur the existing background portion, for example using a suitable alpha mask.

The system 10 also includes at least one filter, for example a colour rebalancer 30 that is used to improve the colour levels of the foreground portion relative to the selected replacement background content. If the selected replacement background content is an image, this is achieved by analysing a RGB histogram of the background image. If the selected replacement background content is video, the RGB histogram of the background video is averaged over time.

In an embodiment, the colours of the RGB histogram of the background content are weighted based on their spatial position so that colours in lower and central parts of the image have a greater effect on an overall colour average. Using the weighted colours of the background, the colour rebalancer 30 generates a gamma value for each RGB colour channel of the foreground portion of the image that is used to adjust the average of each colour channel of the foreground portion to be in accordance with the respective colour averages of the background portion of the image.

This process serves to match the colour tone and brightness of the foreground portion of the image to the background portion of the image which makes the composite image frames appear more natural.

In an alternative embodiment, the background colour average is weighted based on the location of the foreground portion relative to the background portion when the foreground portion is overlaid on the replacement background content. For example, if the foreground overlay is positioned on the right hand side of the replacement background content, then the background content average is more heavily weighted towards the left hand side of the image. This process further enhances the composite image of the foreground and background layers as it simulates ambient light.

However, it will be understood that other arrangements are possible. For example, instead of modifying the colour tone and brightness of the foreground portion to match with the background content, the colour tone and brightness of the background content may be modified to match with the foreground portion.

The system may include other filters applicable to the foreground portion and/or the replacement background content, including colour filters that apply a special effect and/or improve the combination of foreground and background graphics. For example, a sepia tone may be applied to both the foreground portion and the replacement background content. Alternatively, the foreground portion may be filtered in a different way to the background content. For example, the foreground portion may have increased brightness and the background content decreased brightness so that the foreground portion stands out from the background content. Other spatial filters such as image sharpening or blurring filters may also be applied to the foreground portion and/or background content.

The system also includes a compositor (e.g., compositor circuit) 32 arranged to use the high resolution alpha matte generated by the alpha matte generator 20 (or the high resolution alpha matte as modified by the user editor 24) to combine the identified foreground portion with the replacement background content (which has been filtered by the video filter 22 and optionally colour rebalanced by the colour rebalancer 30). The composite video stream is then displayed on the display 15 of the computing device. This process uses standard compositing techniques to overlay the foreground portion onto the replacement background content with transparency determined according to the high resolution alpha matte so that the foreground portion is effectively superimposed on the replacement background portion.

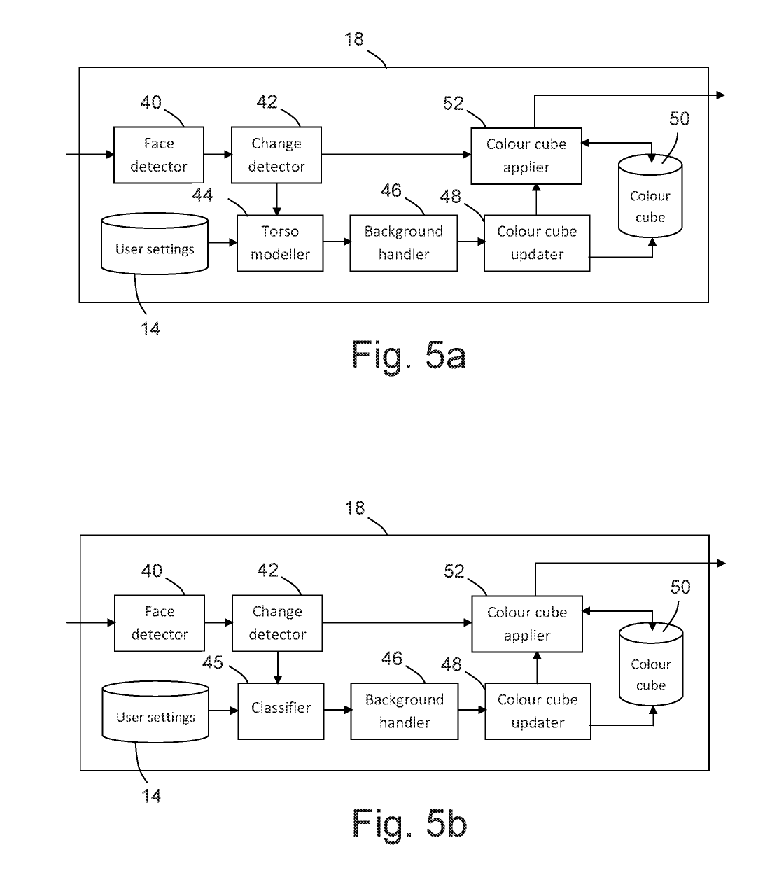

Functional components of an example foreground determiner circuit 18 are shown in more detail in FIG. 5a. The functional components include a face detector 40 arranged to detect and track a face in video frames of the video stream produced by the video camera 12. Any suitable method for detecting a face and determining the size and location of the face is envisaged. In this example, industry standard Haar like face detectors are used to identify and track target faces in the sub sampled video frames. A Haar detector typically identifies several possible faces, and in the present embodiment the face detector 40 is arranged to only process the detected face with the strongest response from the Haar detector. After detecting a face, the face detector 40 generates a bounding box that identifies the size and position of the detected face relative to the video frame. The bounding box is used to model the torso of the person associated with the detected face. However, while the present embodiment is arranged to detect only one face, it will be understood that multiple faces may be detected and tracked by the face detector 40 to allow for applications wherein it is desired to replace the background portion of a video stream that includes multiple people with a substitute background.

In an alternative embodiment, a facial landmark detector can be used to determine face location data suitable for torso modelling. A facial landmark detector is capable of identifying the location in an image of pixels representing points of interest on a human face. Such points of interest are features such as the mouth, nose, eyes and outline of the chin. These points of interest are referred to as facial landmarks. A range of different techniques, known to those skilled in the art, can be used to identify facial landmarks and track them over a video sequence in real-time. The output of a facial landmark detector can be used to derive facial location data such as a bounding box and also other parameters such as the orientation of the person's face relative to the camera which can be directly used to control the parameterisation of the torso modeller.

The functional components also include a change detector 42 arranged to determine whether significant changes exist between a video frame and a previous video frame. If significant changes do exist, a fresh alpha matte is generated.

If significant changes between successive video frames are detected, a torso modeller 44 is activated by the change detector 42, the torso modeller 44 using the bounding box generated by the face detector 40 to generate a model of the head and upper body of the user associated with the detected face. In this example, the torso modeller 44 uses a parameterised model of the head and upper body, the parameters including measurements such as the position and radius of the skull, the width of the neck, and the height of the left and right shoulders measured relative to the position of the detected face.

The parameters of the torso model may be varied within a defined range. For example, the maximum face radius may be based on detected face rectangles. The torso modeller 44 also examines colour histograms from inside and outside of the expected torso, and analyses the expected torso location given the determined face location and prior training data. The best fit torso is then selected for the video frame. The user may guide the torso modelling step by providing information about an ideal torso model through the user interface, and storing additional torso information for use by the torso modeller in the user settings 14. For instance, the user may indicate that their head is narrower and taller than the default configuration or that their shoulders are wider than the default configuration. In this case, the torso modeller parameterised model is adapted to vary within a modified range.

In an embodiment wherein a facial landmark detector is used, the facial location data produced by the facial landmark detector may be used by the torso modeller 44. For example, if the facial landmark detector indicates that the user's head is rotated to the left, then the torso modeller 44 may be arranged to adjust the parameters of the torso in the knowledge that the head is likely to be wider in the horizontal axis than it would be if the user was directly facing the camera.

The functional components of the foreground determiner circuit 18 also include a background handler 46 arranged to identify pixels in a video frame that fall outside the basic torso model, but which actually should properly form part of the foreground portion. For example, since the basic torso model does not include arms or hands, pixels in the video frame that correspond to arms and hands are not identified by the torso modeller 44 as part of the torso model but nevertheless should form part of the detected foreground portion. Initially all pixels that fall outside of the torso model are identified as background. In this example, the background handler 46 stores average RGB values for each pixel identified by the torso modeller 44 as background.

For each pixel in a video frame, the background handler stores information about which RGB colours have occurred at that pixel. The colour ranges are represented by a colour cluster centroid in RGB space. For example, a pixel in the background image may have a cluster centroid at red=200, blue=0, green=0 representing a section of the background that is bright red. When a new video frame arrives, the RGB value at the pixel location is compared to the existing colour cluster centroids in the background model. If the colour is close to the existing centroid then the pixel is deemed to fit with this cluster. In this context, ‘close’ is defined as the combined differences between the red, green and blue colour components using a standard sum of absolute differences (SAD) measure. In the preferred embodiment, the threshold for belonging to a cluster is set to 10% of the maximum possible SAD value. As additional pixels are added to the background model, the threshold is adapted based on the variance or noise of the values in the cluster. If the variance of the colours in the cluster is large the threshold is increased. Each cluster also has a count indicating how many pixels were included in the cluster.

Each pixel in the background handler can store up to 4 different colour clusters. This improves the ability of the background handler to adapt to small changes in the image and deal with parts of the background that may be dis-occluded (uncovered). If a new pixel does not belong to any of the existing clusters a new cluster is created for this pixel using the pixel's RGB value as the centroid.

To improve the ability of the background handler to adapt to changes in the lighting conditions over time the clusters are updated at each frame. In the preferred embodiment the pixel count of a cluster is reduced over time. For each frame, if the pixel does not belong to an existing cluster the pixel count of the cluster is reduced by 1. If the pixel count of the cluster reaches zero, the cluster is deleted to allow for new clusters to be created.

The components also include a colour cube updater 48 arranged to manage creation and updating of a colour cube 50. A colour cube is a data storage structure arranged to store associations between pixel RGB colour, pixel XY position and the alpha matte value associated with the pixel. The colour cube 50 is created and updated by averaging the RGB results from the background handler 46.

The colour cube quantizes the entire RGB XY space into a smaller set of samples or bins to save space and improve performance. In the preferred embodiment, 32 bins are used for the RGB colour space, with each colour bin covering a range of colours, and 20 bins are used for the XY positions, with each XY bin covering a range of positions. After the alpha value of a specific pixel has been estimated or determined, the RGB colour and XY position of the pixel is added to the colour cube 50 by adding the alpha value to the quantized RGB/XY bin in the cube. The alpha values of pixels in these bins are averaged.

The components also include a colour cube applier 52 arranged to apply the colour cube 50 to the sub sampled video stream in order to generate a low resolution alpha matte.

To determine the sub-sampled alpha matte of pixels in a video frame from the camera 12, the RGB and XY information associated with each pixel is matched by the colour cube applier 52 to the closest bin in the colour cube 50 and the averaged alpha matte value stored in the colour cube 50 is assigned as the pixel's alpha value.

The colour cube 50 may be updated at every video frame by weighting the contribution of the current frame with the existing data from previous video frames already stored in the colour cube 50.

If the change detector 42 determines that significant changes do not exist between a video frame and a previous video frame, an existing colour cube is applied to the video frame.

The foreground determiner circuit 18 runs asynchronously to the main video processing loop shown in FIG. 1 whereby the high resolution video stream is filtered by the video filter 22 and processed with the high resolution alpha matte and the replacement background content to produce a new composite video stream. At any time, the foreground determiner circuit 18 is able to output a low resolution alpha matte based on an input video frame that is used by the alpha matte generator 20 to generate a high resolution alpha matte. In order to minimize the processing load on the foreground determiner circuit 18 and thereby the user computing device, the foreground determiner circuit 18 may run at a lower frame rate than the video refresh rate used by the display 34. For example, the video rate used by the display may be 30 frames per second and the foreground determiner circuit 18 arranged to generate an alpha matte at about 10 frames per second.

In this embodiment, the change detector 42 is arranged to detect significant changes in the scene. If the position of the face detected by the face detector 40 has not moved very far from its previous position, it is assumed that the scene has not changed significantly, and in this case the existing colour cube 50 is applied to generate the low resolution alpha matte. If a more significant change in the position of the face is detected by the change detector 42, then if necessary, the video pipeline is stalled until the torso model has been generated by the torso modeller 44 and the colour cube 50 has been updated by the colour cube updater 48.

As an alternative to the torso modeller 44, the foreground determiner circuit may include a classifier 45 arranged to detect foreground pixels, as shown in FIG. 5b. The classifier may be configured to classify all pixels in a video frame as foreground or background depending on the pixel colour (RGB) and pixel position (x,y) relative to other pixels in the video frame. The position of a detected face can be used to provide additional inputs into the classifier. A Convolutional Neural Network (CNN), also known as ConvNets, can be used as a suitable classifier.

A CNN can be trained to classify pixels as foreground or background with an associated probability. A CNN or other suitable classifier can be configured to output an alpha matte indicative of the foreground area and, as such, a CNN is a viable alternative to geometric torso modelling. In order to train the CNN, a sufficiently large sample of example data in which each pixel is marked as foreground or background is used to train the network using standard CNN techniques such as back propogation. The training process is conducted offline in non-realtime. After the CNN has been successfully trained, the network comprises of several weights and biases that are multiplied with the classifier input to generate an alpha matte mask. The process of applying the classifier therefore involves passing the low resolution video frames through the CNN and applying the appropriate weights and biases to generate a low resolution alpha matte for input to the background handler 46.

However, it will be understood by those skilled in the art that other classifiers, including classifiers that do not require training, can be used to generate an output alpha matte based on input pixels from the low resolution video frames.

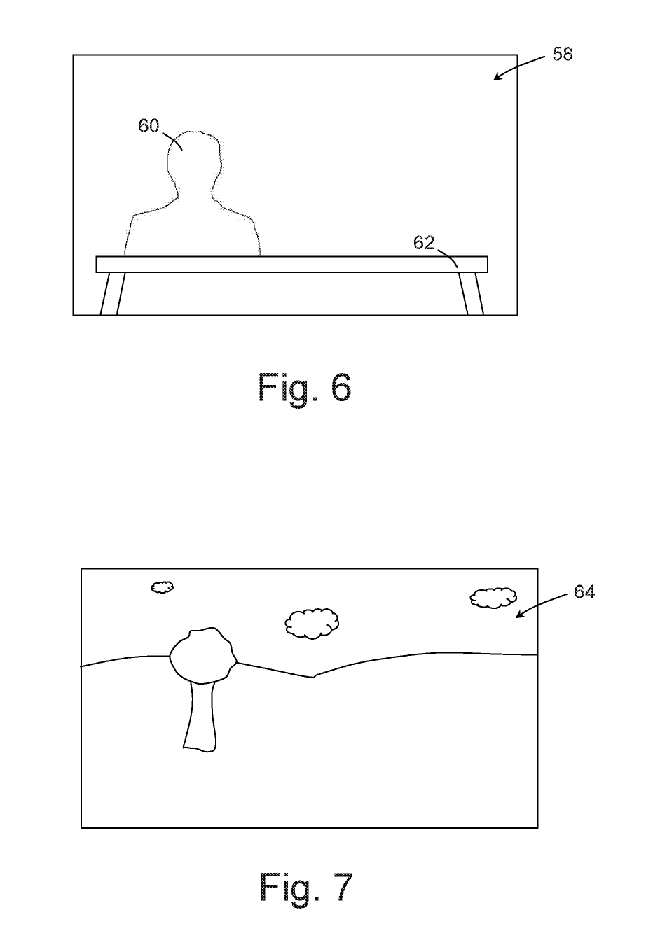

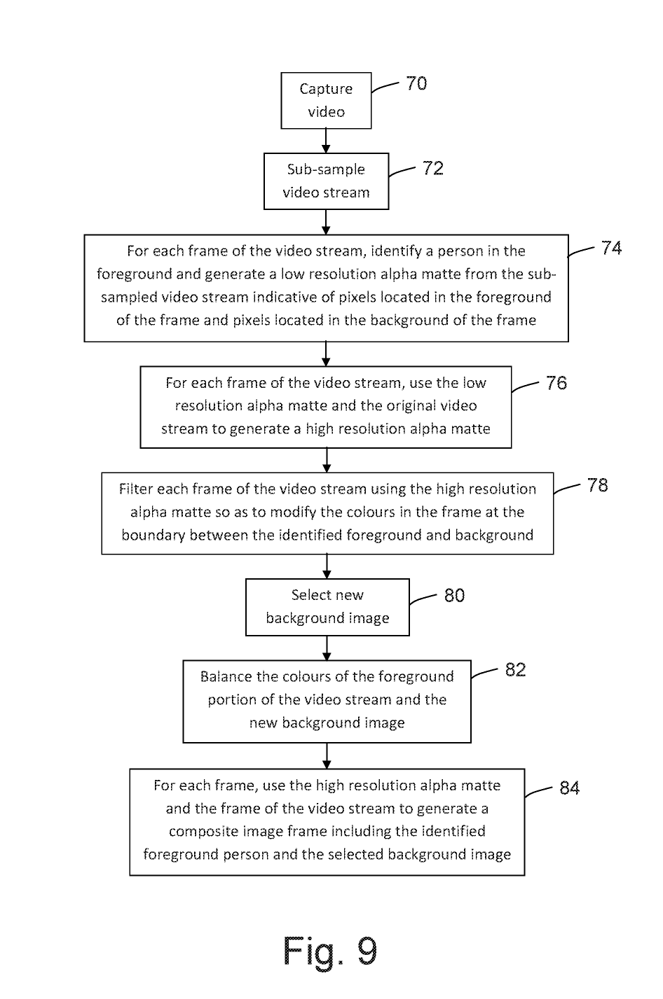

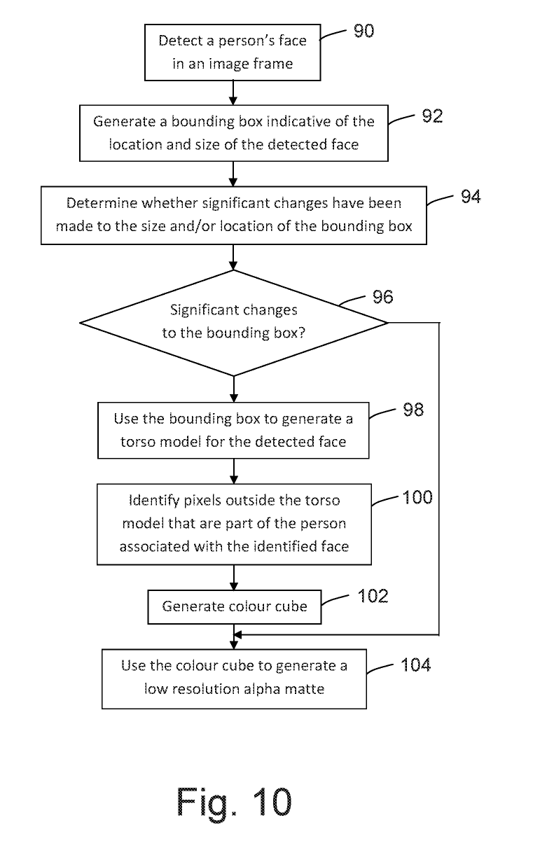

Referring to FIGS. 6 to 10, an example implementation during use will now be described. The example implementation includes a smart phone 11 provided with a video camera 12 that produces a video stream, although it will be understood that the video stream may be obtained from any suitable source, such as from a suitable video storage device or from a source connected to the system through a network such as the Internet. FIG. 9 shows steps 70 to 84 of a method of replacing a background portion in a video stream with replacement background content, and FIG. 10 shows steps 90 to 104 of a method of determining foreground and background portions of frames in a video stream.

Referring to FIG. 9, during use, a user manipulates the smart phone 11 so as to capture 70 a video stream 58 of the user. For example, as shown in FIG. 6, a video is captured 70 of the user 60 in a room adjacent a table 62.

The video stream produced by the camera 12 is sub-sampled 72 by the spatial sub-sampler 16 in order to reduce the resolution of the video stream and thereby reduce the processing power required to process the video stream. The sub-sampled video stream is then processed 74 by the foreground determiner circuit 18 so as to detect the presence of a person in the video stream as a foreground portion in a background scene, and so as to generate a low resolution alpha matte indicative of pixels that are located in the foreground portion and pixels that are located in the background portion. The low resolution matte is then used together with the original video stream to generate 76 a high resolution alpha matte.

As indicated at step 78, the high resolution video stream is then filtered 78 using the high resolution alpha matte so as to modify the colours at the boundary between the foreground and background portions and thereby reduce bleeding effects from the background.

The user selects 80 new background content to be used to replace the background portion in the video stream. For example, as shown in FIG. 7, the new background content in this example is an image of a country scene 64.

In this example, the colours of the foreground portion and the selected background content are balanced 82 using a colour balancer 30 so as to avoid noticeable differences in colour tone and brightness between the foreground and replacement background.

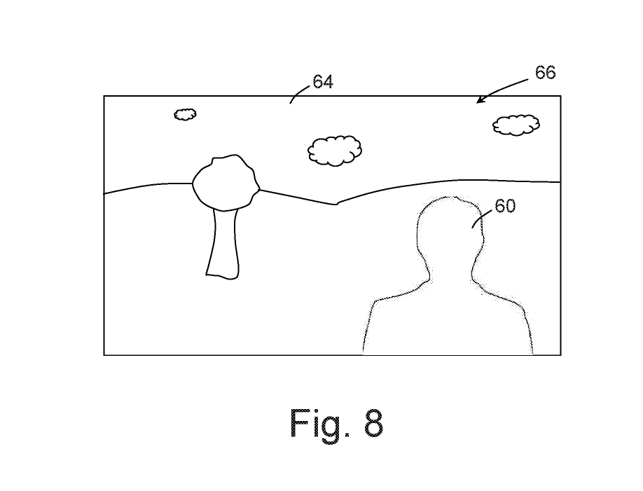

As indicated at step 84, using the high resolution alpha matte, a video frame of the video stream is combined with the replacement background content such that the foreground portion is superimposed on the replacement background image. As shown in FIG. 8, the result in this example is a composite video stream 66 that includes the foreground portion (the user) 60 superimposed on the selected background content 64.

The method of determining foreground and background portions of frames in a video stream implemented by the foreground determiner circuit 18 is shown in more detail in FIG. 10.

A face detector 40 detects 90 a person's face in a video frame of the sub-sampled video stream and generates 92 a bounding box indicative of the location and size of the detected face. By detecting changes to the location and size of the bounding box, the change detector 42 then determines 94 whether significant changes have been made to the video stream between successive video frames, and if significant changes are detected the bounding box is used by the torso modeller 44 to generate 98 a torso model for the detected face. As indicated at step 100, the background handler 46 then identifies pixels that are outside the torso model but are properly part of the person associated with the detected face, and the colour cube updater 48 generates or updates a colour cube 50. The generated or updated colour cube 50 is used to generate 104 a low resolution alpha matte.

If significant changes are not detected, the existing colour cube is used to generate 104 the low resolution alpha matte, as indicated at step 104.

Modifications and variations as would be apparent to a skilled addressee are deemed to be within the scope of the present invention.

Information and signals disclosed herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, and algorithm steps described in connection with the embodiments disclosed herein may be implemented as electronic hardware, computer software, or combinations of both. To clearly illustrate this interchangeability of hardware and software, various illustrative components, blocks, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may be implemented in hardware, software, firmware, or any combination thereof. Such techniques may be implemented in any of a variety of devices such as general purposes computers, wireless communication device handsets, or integrated circuit devices having multiple uses including applications in wireless communication device handsets, automotive, appliances, wearables, and/or other devices. Any features described as devices or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise a memory circuit (e.g., a storage device) or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a hardware processor (e.g., a hardware processor circuit), which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software or hardware configured for encoding and decoding, or incorporated in a combined video encoder-decoder (CODEC). Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, or units are described in this disclosure to emphasize functional aspects of devices configured to perform the disclosed techniques, but do not necessarily require realization by different hardware units. Rather, as described above, various units may be combined in a codec hardware unit or provided by a collection of inter-operative hardware units, including one or more processors as described above, in conjunction with suitable software and/or firmware.

Although the foregoing has been described in connection with various different embodiments, features or elements from one embodiment may be combined with other embodiments without departing from the teachings of this disclosure. However, the combinations of features between the respective embodiments are not necessarily limited thereto. Various embodiments of the disclosure have been described. These and other embodiments are within the scope of the following claims.

1. A video background processing system, comprising:
a memory device configured to store a video stream including a plurality of successive first video frames at a first resolution;
a hardware processor configured to:
reduce the resolution of the plurality of successive first video frames from the first resolution to a second resolution lower than the first resolution and thereby generate a plurality of second video frames;
determine a foreground portion and a background portion in the plurality of second video frames and to produce first data indicative of locations of the foreground and background portions in the plurality of second video frames at the second resolution;
use the first data to generate second data indicative of locations of the foreground and background portions in the plurality of successive first video frames; and
use replacement background content and the second data to generate a plurality of combined video frames at the first resolution, each combined video frame including the foreground portion from a first video frame and the replacement background content.

2. A video background processing system as claimed in claim 1, wherein the first data is a first alpha matte wherein each pixel of the first alpha matte is indicative of whether an associated pixel in the plurality of second video frame is part of the foreground portion or part of the background portion, the first alpha matte having a first alpha matte resolution.

3. A video background processing system as claimed in claim 2, wherein each pixel of the first alpha matte has an associated first alpha value representing a transparency of the pixel.

4. A video background processing system as claimed in claim 1, wherein the foreground portion is an image of a person.

5. A video background processing system as claimed in claim 1, wherein the hardware processor is includes a face detector configured to detect a face in a second video frame.

6. A video background processing system as claimed in claim 5, wherein the hardware processor includes a torso modeller configured to generate a torso model of a head and upper body of the person associated with the detected face.

7. A video background processing system as claimed in claim 6, wherein the processor includes a background handler configured to identify pixels in a second video frame that fall outside the torso model, but that properly form part of the foreground portion.

8. A video background processing system as claimed in claim 1, wherein the processor includes a classifier configured to detect pixels in the foreground portion.

9. A video background processing system as claimed in claim 8, wherein the classifier is configured to classify each pixel in a second video frame as foreground or background depending on the pixel colour (RGB) and position (x,y) of the pixel relative to other pixels in the second video frame.

10. A video background processing system as claimed in claim 8, wherein the classifier comprises a Convolutional Neural Network (CNN) configured to classify pixels as foreground or background with an associated probability.

11. A video background processing system as claimed in claim 2, wherein the processor includes a colour cube configured to store associations between pixel RGB colour, pixel XY position and the first alpha matte value associated with a pixel.

12. A video background processing system as claimed in claim 11, comprising a plurality of colour bins for RGB colour space, each colour bin associated with a defined range of colours, and a plurality of position bins for XY positions, each XY bin associated with a defined range of positions, wherein the processor is configured to apply the colour cube to the plurality of second video frames in order to generate the first alpha matte by matching RGB and XY information associated with each pixel to the closest bin in the colour cube and assigning the first alpha matte value stored in the colour cube as the first alpha matte value for the pixel.

13. A video background processing system as claimed in claim 11, wherein the processor includes a colour cube updater configured to manage creation and updating of the colour cube.

14. A video background processing system as claimed in claim 12, wherein the processor includes a change detector configured to determine whether significant changes exist between a second video frame and a previous second video frame, wherein if significant changes are determined to exist, a new first alpha matte is generated, and if significant changes are not determined to exist, an existing colour cube is used.

15. A video background processing system as claimed in claim 1, wherein the hardware processor includes a spatial sub sampler configured to reduce the resolution of the plurality of successive first video frames from the first resolution to the second resolution lower than the first resolution and thereby generate the plurality of second video frames.

16. A video background processing system as claimed in claim 1, wherein the second data is a second alpha matte, and the system comprises an alpha matte generator configured to use the first alpha matte and the plurality of first video frames to generate the second alpha matte, each pixel of the second alpha matte being indicative of whether an associated pixel in the first video frame is part of the foreground portion or part of the background portion, and the second alpha matte having a second alpha matte resolution higher than the first alpha matte resolution.

17. A video background processing system as claimed in claim 1, comprising at least one filter for application to the foreground portion and/or the replacement background content.

18. A video background processing system as claimed in claim 17, wherein the at least one filter comprises a boundary filter configured to adjust the plurality of successive first video frames by modifying colours in the plurality of successive first video frames at a boundary between the foreground portion and the background portion.

19. A video background processing system as claimed in claim 17, wherein the at least one filter includes a colour rebalancer configured to modify the relative colour tone and/or brightness of the foreground portion and the replacement background content.

20. A video background processing system as claimed in claim 19, wherein the colour rebalancer is configured to analyse a RGB histogram of the foreground portion or the replacement background content, and to calculate an average of the RGB histogram of the foreground portion or the replacement background content over a defined time period.

21. A video background processing system as claimed in claim 20, wherein the colours of the RGB histogram of the background are weighted based on their spatial position.

22. A video background processing system as claimed in claim 17, wherein the at least one filter comprises a colour filter applicable to the foreground portion and/or the replacement background content; a filter configured to apply increased brightness to the foreground portion and/or to apply decreased brightness to the replacement background content; an image sharpening filter; and/or an image blurring filter.

23. A video background processing system as claimed in claim 1, wherein the system comprises a user editor configured to enable the user to indicate a portion of a video frame that has been incorrectly assigned to a foreground portion or a background portion, and in response the system reassigns the indicated incorrectly assigned portion to the relevant correct foreground or background portion.

24. A video background processing system as claimed in claim 1, comprising user settings indicative of user configurable settings usable by components of the system.

25. A video background processing system as claimed in claim 24, wherein the user configurable settings enable a user to control a trade-off between performance and quality.

26. A video background processing system as claimed in claim 25, wherein the processor is configured to reduce the resolution of the plurality of successive first video frames from the first resolution to a second resolution using a video down sampling factor, and the user configurable settings include a setting that enables a user to select the video down sampling factor.

27. A video background processing system as claimed in claim 1, wherein the replacement background content is derived from existing background content in the video stream by modifying existing background content.

28. A video background processing system as claimed in claim 27, wherein the replacement background content is produced by applying an image modifier configured to blur the existing background portion.

29. A video background processing system as claimed in claim 1, wherein the system comprises a background content storage device configured to store replacement background content.

30. A video background processing system as claimed in claim 29, comprising a selector configured to facilitate selection of replacement background content.

31. A method of replacing a background portion in a video stream having a foreground portion and the background portion, the method comprising:
receiving a video stream including a plurality of successive first video frames at a first resolution;
reducing the resolution of the plurality of successive first video frames from the first resolution to generate a plurality of second video frames at a second resolution lower than the first resolution;
determining a foreground portion and a background portion in the plurality of second video frames and producing first data indicative of locations of the foreground and background portions in the plurality of second video frames at the second resolution;
using the first data to generate second data indicative of locations of the foreground and background portions in the plurality of second video frames; and
using replacement background content and the second data to generate a plurality of combined video frames at the first resolution, each combined video frame including the foreground portion in a first video frame and the replacement background content.

32. A method as claimed in claim 31, wherein the first data is a first alpha matte wherein each pixel of the first alpha matte is indicative of whether an associated pixel in the second video frame is part of the foreground portion or part of the background portion, the first alpha matte having a first alpha matte resolution.

33. A method as claimed in claim 31, wherein determining a foreground portion and a background portion in the plurality of second video frames comprises detecting a face in a second video frame, and generating a torso model of a head and upper body of a person associated with the detected face.

34. A method as claimed in claim 31, wherein determining a foreground portion and a background portion in the plurality of second video frames comprises using a classifier to detect pixels in the foreground portion, the classifier configured to classify each pixel in a second video frame as foreground or background depending on the pixel colour (RGB) and position (x,y) of the pixel relative to other pixels in the second video frame.

35. A method as claimed in claim 32, comprising using a colour cube to store associations between pixel RGB colour, pixel XY position and the first alpha matte value associated with a pixel, the colour cube quantizing RGB XY space into a set of bins comprising a plurality of colour bins for RGB colour space, each colour bin associated with a defined range of colours, and a plurality of position bins for XY positions, each position bin associated with a defined range of positions, and applying the colour cube to the plurality of second video frames in order to generate the first alpha matte by matching RGB and XY information associated with each pixel to the closest bin in the colour cube and assigning the first alpha matte value stored in the colour cube as the first alpha matte value for the pixel.

36. A method as claimed in claim 35, comprising determining whether significant changes exist between a second video frame and a previous second video frame, wherein:
if significant changes are determined to exist, generating a new first alpha matte; and
if significant changes are not determined to exist, using an existing colour cube.

37. A method as claimed in claim 31, wherein the second data is a second alpha matte, and the method comprises using the first alpha matte and the plurality of successive first video frames to generate the second alpha matte, each pixel of the second alpha matte being indicative of whether an associated pixel in a first video frame is part of the foreground portion or part of the background portion, and the second alpha matte having a second alpha matte resolution higher than the first alpha matte resolution.

38. A method as claimed in claim 31, comprising applying at least one filter to the foreground portion and/or the replacement background content.

39. A method as claimed in claim 38, wherein the at least one filter comprises a boundary filter configured to adjust the plurality of successive first video frames by modifying colours in the plurality of successive first video frames at a boundary between the foreground portion and the background portion; a colour rebalancer configured to modify the relative colour tone and/or brightness of the foreground portion and the replacement background content; a colour filter applicable to the foreground portion and/or and the replacement background content; a filter configured to apply increased brightness to the foreground portion and/or to apply decreased brightness to the replacement background content; an image sharpening filter; and/or an image blurring filter.

40. A method as claimed in claim 31, comprising enabling a user to indicate a portion of a video frame that has been incorrectly assigned to a foreground portion or a background portion, and in response reassigning the indicated incorrectly assigned portion to the relevant correct foreground or background portion.

41. A method as claimed in claim 31, comprising enabling a user to modify a user setting that controls a trade-off between performance and quality.

42. A method as claimed in claim 41, wherein reducing the resolution of the plurality of successive first video frames from the first resolution to the second resolution comprises reduce the resolution of the plurality of successive first video frames from the first resolution to a second resolution using a video down sampling factor, and the method comprises enabling a user to select the video down sampling factor.

43. A method as claimed in claim 31, comprising producing the replacement background content from existing background content in the video stream by modifying existing background content.

44. A method as claimed in claim 43, wherein the replacement background content is produced by applying an image modifier configured to blur the existing background content.

45. A method as claimed in claim 31, comprising storing replacement background content, and facilitating selection of replacement background content.

46. A method as claimed in claim 45, wherein the selector is configured to facilitate selection of replacement background content automatically or by a user.

47. A video background processing system, the system configured to receive a video stream including a plurality of successive first video frames at a first resolution, the system comprising:
a video resolution modifier circuit configured to reduce the resolution of the plurality of successive first video frames from the first resolution to a second resolution lower than the first resolution and thereby generate a plurality of second video frames;
a foreground determiner circuit configured to determine a foreground portion and a background portion in the plurality of second video frames and to produce first data indicative of locations of the foreground and background portions in the plurality of second video frames at the second resolution, wherein the system is configured to use the first data to generate second data indicative of locations of the foreground and background portions in the plurality of successive first video frames; and
a compositor circuit configured to use replacement background content and the second data to generate a plurality of combined video frames at the first resolution, each combined video frame including the foreground portion from a first video frame and the replacement background content.
